(19) United States
(12) Patent Application Publication
(10) Pub. No.: US 2025/0364735 A1
(43) Pub. Date: Nov. 27, 2025

(54) CONNECTOR

(71) Applicant: Yazaki Corporation, Tokyo (JP)

(72) Inventors: Atsunori Iwashita, Shizuoka (JP); Masahiro Nakagawa, Shizuoka (JP); Takahiro Kubo, Shizuoka (JP); Masayuki Ishigami, Shizuoka (JP)

(73) Assignee: Yazaki Corporation, Tokyo (JP)

(21) Appl. No.: 19/205,059

(22) Filed: May 12, 2025

(30) Foreign Application Priority Data
May 21, 2024 (JP) 2024-082582

(51) Int. Cl. H01R 4/30; H01R 13/512

(52) U.S. Cl. CPC H01R 4/30; H01R 13/512

(57) ABSTRACT

A connector including a first housing, a second housing configured to be fitted to the first housing, a first conductive member being accommodated in the first housing and including a first through hole, a second conductive member being accommodated in the second housing and including a second through hole arranged at a position matching with the first through hole while the first housing and the second housing are fitted to each other, and a bolt configured to electrically connect the first conductive member and the second conductive member to each other by being inserted into the first through hole and the second through hole for fastening, the second through hole is provided with an insertion opening into which the bolt is configured to be inserted, the insertion opening being opened toward a fitting direction of the first housing and the second housing.

### CROSS-REFERENCE TO RELATED APPLICATIONS

The present application is based on, and claims priority from the prior Japanese Patent Application No. 2024-082582, filed on May 21, 2024, the entire contents of which are incorporated herein by reference.

### TECHNICAL FIELD

The present disclosure relates to a connector.

### BACKGROUND

Hitherto, there has been known a connector including a first housing, a second housing that can be fitted to the first housing, and a first conductive member that is accommodated in the first housing and includes a first through hole. The connector further includes a second conductive member that is accommodated in a second housing and includes a second through hole arranged at a position matching with the first through hole while the first housing and the second housing are fitted to each other. The connector further includes a bolt that is inserted into the first through hole and the second through hole for fastening and electrically connects the first conductive member and the second conductive member to each other (see JP 2016-213048 A).

In the connector, when the first housing and the second housing are fitted to each other, the first through hole of the first conductive member and the second through hole of the second conductive member are arranged at the matching position. The bolt is inserted into the first through hole and the second through hole for fastening, thereby electrically connecting the first conductive member and the second conductive member to each other.

### SUMMARY OF THE INVENTION

Incidentally, in the connector as disclosed in JP 2016-213048 A, the bolt is inserted into the first through hole and the second through hole. Thus, for example, when the first housing and the second housing are to be fitted to each other while the bolt is temporarily held in the first through hole, the bolt cannot be inserted into the second through hole, and fitting therebetween cannot be achieved. Meanwhile, when fastening of the bolt is loosened to cancel fitting between the first housing and the second housing while the bolt is inserted into the first through hole and the second through hole, the bolt is caught in the first through hole and the second through hole, and fitting cannot be canceled. Thus, removal of the bolt is required for achieving or cancelling fitting between the first housing and the second housing, and management such as storage of the bolt in addition to that of the connector is required, which leads to degradation of assemblability.

The present disclosure has been made in view of such a problem in the related art. Further, an object of the present disclosure is to provide a connector that can improve assemblability.

A connector according to the present embodiment includes a first housing, a second housing configured to be fitted to the first housing, a first conductive member being accommodated in the first housing and including a first through hole, a second conductive member being accommodated in the second housing and including a second through hole arranged at a position matching with the first through hole while the first housing and the second housing are fitted to each other, and a bolt configured to electrically connect the first conductive member and the second conductive member to each other by being inserted into the first through hole and the second through hole for fastening, wherein one of the first through hole and the second through hole is provided with an insertion opening into which the bolt is configured to be inserted, the insertion opening being opened toward a fitting direction of the first housing and the second housing.

According to the present disclosure, a connector that can improve assemblability can be provided.

### BRIEF DESCRIPTION OF DRAWINGS

FIG. 1 is a perspective view of a connector according to the present embodiment.

FIG. 2 is a cross-sectional view of the connector according to the present embodiment.

FIG. 3 is an enlarged top view of main parts, illustrating a state in which a bolt is arranged in a second through hole from an insertion opening of a second conductive member of the connector according to the present embodiment.

FIG. 4 is a perspective view of a first conductive member of the connector according to the present embodiment.

FIG. 5 is a perspective view of the second conductive member of the connector according to the present embodiment.

FIG. 6 is an enlarged top view of main parts of the second conductive member of the connector according to the present embodiment.

### DETAILED DESCRIPTION OF THE INVENTION

With reference to the drawings, a connector according to the present embodiment is described in detail. Note that the dimensional ratios in the drawings are exaggerated for explanatory purposes, and may differ from the actual ratios.

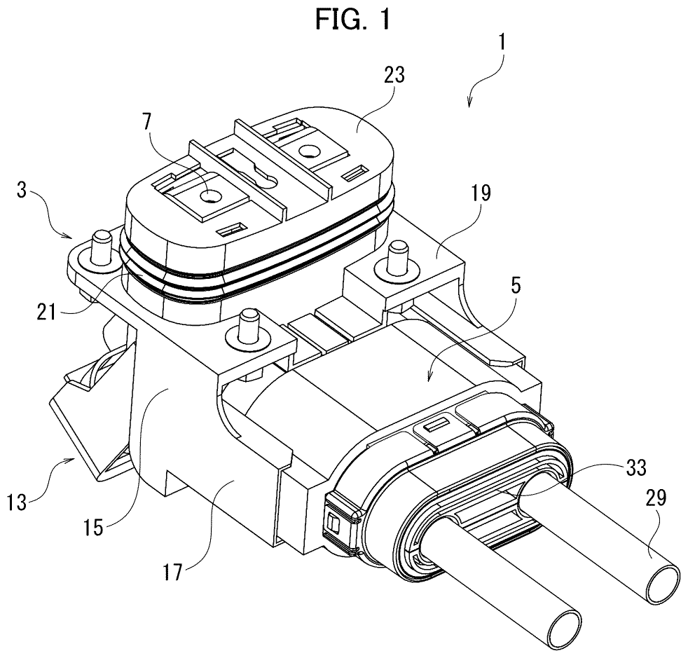

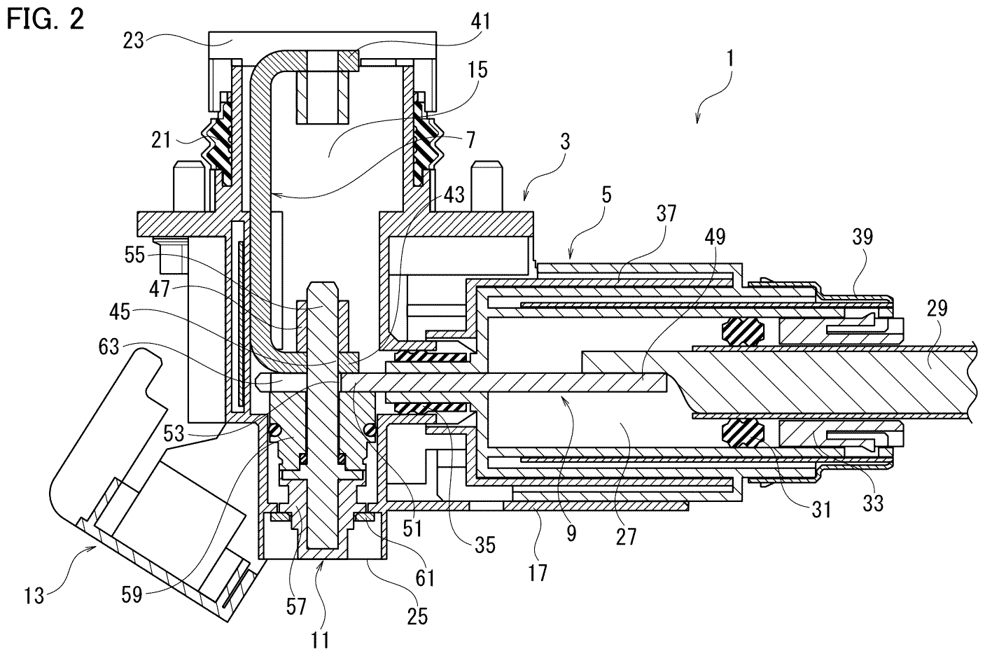

As illustrated in FIG. 1, a connector 1 according to the present embodiment electrically connects two electric components (omitted in illustration), for example, a power source and a device, or a device and a device to each other. The connector 1 includes a first housing 3 that accommodates a first conductive member 7 (see FIG. 2) electrically connected to one electric component and a second housing 5 that accommodates a second conductive member 9 (see FIG. 2) electrically connected to the other electric component and can be fitted to the first housing 3. When the first housing 3 and the second housing 5 are fitted to each other, the first conductive member 7 and the second conductive member 9 are arranged to overlap with each other. The first conductive member 7 and the second conductive member 9 that overlap with each other are electrically connected to each other by fastening of a bolt 11 (see FIG. 2). Consequently, the two electric components are electrically connected to each other.

As illustrated in FIG. 1 to FIG. 6, the connector 1 includes the first housing 3, the second housing 5, the first conductive member 7, the second conductive member 9, the bolt 11, and a cover 13.

As illustrated in FIG. 1 and FIG. 2, the first housing 3 is formed of a conductive material such as a metal material. Note that the first housing 3 may be formed of an insulating material such as a synthetic resin. The first housing 3 is formed to have an L-like housing shape so that the first conductive member 7 can be accommodated therein and the second housing 5 can be fitted therein. The first housing 3 includes a plurality of first accommodation portions 15 (specifically, two in this case) that accommodate the first conductive member 7 therein and a fitting portion 17 to which the second housing 5 is fitted. The first accommodation portion 15 and the fitting portion 17 extend in a tubular shape toward directions orthogonal to each other, and communicate with each other inside. On the outer side of the first housing 3, a plurality of fixing portions 19 fixed to the one electric component via a plurality of bolts are provided. On an outer periphery of one end side of the first accommodation portion 15, a first sealing member 21 that closely contacts with the one electric component and seals the space between the first housing 3 and the one electric component is arranged. A sealing holder 23 assembled to close the opening of the first accommodation portion 15 maintains the arrangement position of the first sealing member 21 with respect to the first housing 3. In the sealing holder 23, an opening from which the first conductive member 7 is exposed is provided. On the other end side of the first accommodation portion 15, a plurality of opening portions 25 (specifically, two in this case) are provided, into which the bolt 11 is inserted to electrically connect the first conductive member 7 and the second conductive member 9 to each other.

As illustrated in FIG. 1 and FIG. 2, the second housing 5 is formed of an insulating material such as a synthetic resin. The second housing 5 is formed to have such a housing shape as to accommodate the second conductive member 9 therein and be fitted to the inside of the fitting portion 17 of the first housing 3. On the outer side of the second housing 5, a locking portion (omitted in illustration) that can be engaged with a locked portion (omitted in illustration) provided to the fitting portion 17 of the first housing 3 is provided. When the locking portion and the locked portion are engaged with each other, the fitting state between the first housing 3 and the second housing 5 can be maintained. The second housing 5 includes a plurality of second accommodation portions 27 (specifically, two in this case) that accommodate the second conductive member 9 therein. Each of both the sides of the second accommodation portion 27 in the length direction is opened so that a part of the second conductive member 9 is exposed and an electric wire 29 electrically connected to the second conductive member 9 is drawn to the outside. The end portion side of the electric wire 29 that is drawn from the second housing 5 is electrically connected to the other electric component. On the outer periphery of the electric wire 29 positioned inside the second accommodation portion 27, an electric wire sealing member 31 that closely contacts with the second housing 5 and seals the space between the second housing 5 and the electric wire 29 is arranged. An electric wire sealing holder 33 assembled to close the opening on the drawing side of the electric wire 29 of the second accommodation portion 27 maintains the arrangement position of the electric wire sealing member 31 with respect to the second housing 5. On the outer periphery of the second accommodation portion 27 on the opening side on which a part of the second conductive member 9 is exposed, a second sealing member 35 that closely contacts with the first housing 3 and seals the space between the first housing 3 and the second housing 5 is arranged. On the outer periphery of the second housing 5 on the first housing 3 side, a housing shielding member 37 that is electrically connected to the first housing 3 and forms a shielding circuit at the time of fitting to the fitting portion 17 of the first housing 3 is mounted. On the outer periphery of the second housing 5 on the electric wire 29 side, an electric wire shielding member 39 that is electrically connected to a shielding member (omitted in illustration) covering the outer periphery of the electric wire 29 drawn from the second housing 5 and forms a shielding circuit is mounted. The housing shielding member 37 and the electric wire shielding member 39 form the shielding circuits, and thus entry of a noise and the like into the connector 1 and leakage of a noise and the like from the connector 1 can be prevented.

As illustrated in FIG. 1, FIG. 2, and FIG. 4, the first conductive member 7 is formed of a conductive material such as a metal material, and is formed to have a plate-like shape such as a bus bar. The plurality of first conductive members 7 (specifically, two in this case) are used. The first conductive member 7 is formed to have a U-like shape by bending both the end sides toward the same direction. One end side of the first conductive member 7 serves as a component connecting portion 41 that is electrically connected to the one electric component. The component connecting portion 41 is arranged to be exposed from the opening of the sealing holder 23 to the outside of the first housing 3 while the first conductive member 7 is accommodated in the first accommodation portion 15 of the first housing 3. In the component connecting portion 41, a through hole is formed, and a nut is fixed to a position corresponding to the through hole on the inner side of the first housing 3. The bolt (omitted in illustration) is inserted into the through hole and fastened to the nut while the conductive member (omitted in illustration) on the one electric component side is arranged, and thus the component connecting portion 41 electrically connects the first conductive member 7 and the one electric component to each other. The other end side of the first conductive member 7 serves as a first connecting portion 43 electrically connected to the second conductive member 9. In the first connecting portion 43, a first through hole 45 is formed, and a nut 47 to which the bolt 11 is fastened is fixed to a position corresponding to the first through hole 45 on the inner side of the first housing 3. The nut 47 is fixed to the position corresponding to the first through hole 45, and thus it is not required to provide the first housing 3 or the second housing 5 with a fastening portion such as a terminal block to which the bolt 11 is fastened. Thus, the structures of the first housing 3 and the second housing 5 can be simplified. The first connecting portion 43 is arranged at the position corresponding to the opening portion 25 of the first accommodation portion 15 on the inner side of the first housing 3 while the first conductive member 7 is accommodated in the first accommodation portion 15 of the first housing 3.

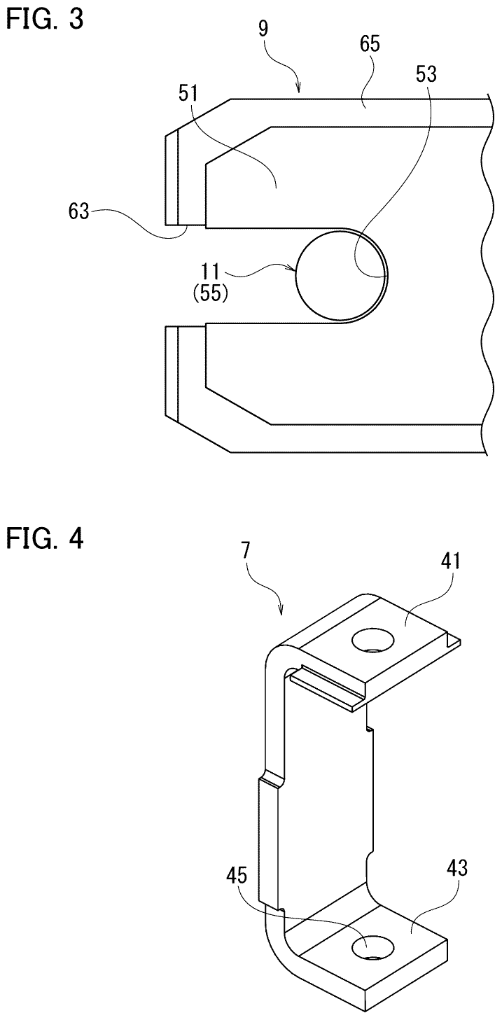

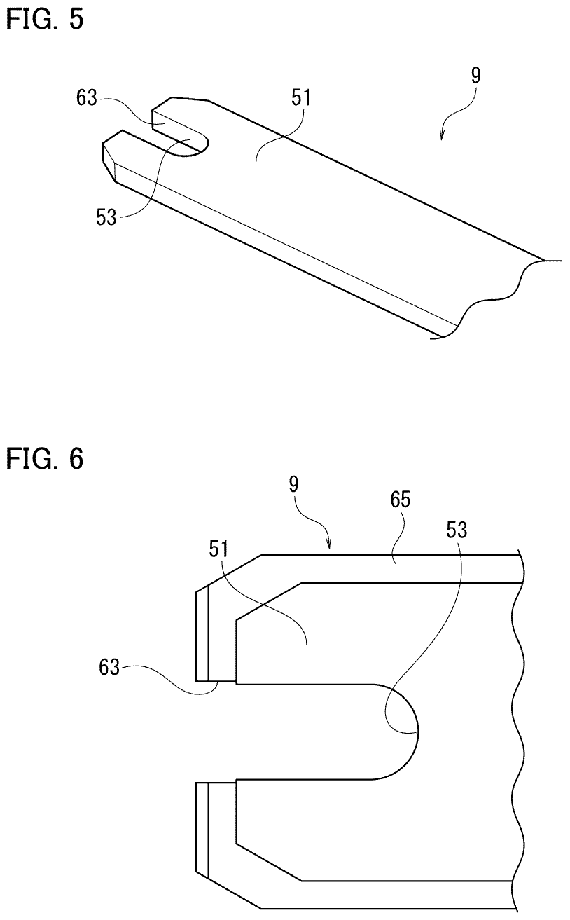

As illustrated in FIG. 2, FIG. 3, FIG. 5, and FIG. 6, the second conductive member 9 is formed of a conductive material such as a metal material, and is formed to have a plate-like shape such as a bus bar. The plurality of second conductive members 9 (specifically, two in this case) are used in correspondence with the first conductive members 7. The second conductive member 9 is formed to have a linear shape extending toward a direction orthogonal to the linear portion of the first conductive member 7. One end side of the second conductive member 9 serves as an electric wire connecting portion 49 electrically connected to a terminal portion of the electric wire 29. The electric wire connecting portion 49 is joined to the terminal portion of the electric wire 29 by crimping or the like, and electrically connects the second conductive member 9 and the electric wire 29 to each other. The other end side of the second conductive member 9 serves as a second connecting portion 51 electrically connected to the first connecting portion 43 of the first conductive member 7. In the second connecting portion 51, a second through hole 53 is formed. The second connecting portion 51 is arranged to be exposed from the opening of the second accommodation portion 27 to the outside of the second housing 5 while the second conductive member 9 is accommodated in the second accommodation portion 27 of the second housing 5. The second connecting portion 51 is arranged to overlap with the first connecting portion 43 of the first conductive member 7 on the inner side of the first housing 3 while the first housing 3 and the second housing 5 are fitted to each other. The first connecting portion 43 and the second connecting portion 51 that overlap with each other are arranged to match with each other so that the first through hole 45 and the second through hole 53 communicate with each other, and are arranged at the position corresponding to the opening portion 25 of the first housing 3. The first connecting portion 43 and the second connecting portion 51 that overlap with each other are electrically connected to each other by inserting the bolt 11 from the opening portion 25, inserting the bolt 11 into the first through hole 45 and the second through hole 53, and fastening the bolt 11 to the nut 47.

As illustrated in FIG. 2 and FIG. 3, the plurality of bolts 11 (specifically, two in this case) are used in correspondence with the plurality of first conductive members 7 and the plurality of second conductive members 9 (specifically, two for each in this case). The bolt 11 includes a fastening portion 55, a resin portion 57, a collar 59, and an engagement portion 61.

The fastening portion 55 is formed of a metal material or the like, for example. The fastening portion 55 is formed to have an axial shape extending along the extension direction of the first accommodation portion 15 of the first housing 3. The outer periphery of the fastening portion 55 is formed to have a screw-like shape that can be fastened to the nut 47 fixed to the first connecting portion 43.

The resin portion 57 is formed of an insulating material such as a synthetic resin, and is arranged on one end side of the fastening portion 55. The resin portion 57 includes an inner surface formed to have a screw-like shape that can be fastened to the fastening portion 55. Note that the resin portion 57 may be insert-molded integrally with the fastening portion 55 so that the fastening portion 55 is positioned inside. The resin portion 57 includes an outer surface formed to have a polygonal shape such as a hexagonal shape that can be fastened by a jig or the like.

The collar 59 is formed of an insulating material such as a synthetic resin, and is arranged on the second connecting portion 51 side with respect to the resin portion 57 in the fastening portion 55. The collar 59 is formed to have an annular shape so that the fastening portion 55 is inserted thereinto and arranged. Inside the collar 59, an O ring is arranged as a sealing member that seals the space between the fastening portion 55 and the collar 59. On the outer periphery of the collar 59, an O ring is arranged as a sealing member that closely contacts with the first housing 3 and seals the space between the first housing 3 and the collar 59.

The engagement portion 61 is formed of an insulating material such as a synthetic resin, and is arranged across the resin portion 57 and the collar 59 in the fastening portion 55. The engagement portion 61 includes an annular portion that is formed to have an annular shape and is engaged with the outer periphery of the resin portion 57 and a plurality of elastic pieces that extend from the annular portion toward the collar 59 and are engaged with the outer surface of the collar 59. By engaging the engagement portion 61 with the resin portion 57 and the collar 59, the bolt 11 can be handled as a single member.

The bolt 11 is inserted from the opening portion 25 of the first housing 3 into the inside of the first housing 3, and is inserted into the second through hole 53 of the second connecting portion 51 and the first through hole 45 of the first connecting portion 43, and thus the fastening portion 55 is arranged at the nut 47. The fastening portion 55 is fastened to the nut 47 by rotating the resin portion 57 by a jig or the like while the fastening portion 55 is arranged at the nut 47. When the fastening portion 55 is fastened to the nut 47, the first connecting portion 43 and the second connecting portion 51 contact with each other so as to be sandwiched between the nut 47 and the collar 59, the first conductive member 7 and the second conductive member 9 are electrically connected to each other, and the two electric components are electrically connected to each other. In contrast, with regard to the bolt 11, fastening between the fastening portion 55 and the nut 47 is cancelled by reversely rotating the resin portion 57 by a jig or the like. When fastening between the fastening portion 55 and the nut 47 is cancelled, the bolt 11 is drawn out from the opening portion 25 to the outside of the first housing 3, and thus the second housing 5 can be removed from the first housing 3. When fitting between the first housing 3 and the second housing 5 is cancelled, electric connection between the first conductive member 7 and the second conductive member 9 is cancelled, and electric connection between the two electric components is cancelled.

As illustrated in FIG. 1 and FIG. 2, the cover 13 is formed of an insulating material such as a synthetic resin. The cover 13 includes a pair of side walls and a coupling wall that couples the pair of side walls, and is formed to have a U-like shape. The cover 13 is assembled to the first housing 3 via an engaging portion (omitted in illustration) so as to be turnable in an opening and closing manner with respect to the opening portion 25 and movable in an advanceable and retractable manner with respect to the opening portion 25 on the outer side of the first housing 3. When fastening of the bolt 11 is achieved or canceled in the opening portion 25, the cover 13 is arranged at an opening position (see FIG. 2) for opening the opening portion 25. When fastening of the bolt 11 is completed, the cover 13 turns from the opening position, moves away from the opening portion 25, and is arranged at a standby position (omitted in illustration) facing the opening portion 25. The cover 13 moves from the standby position toward the opening portion 25, and is arranged at an assembly position (omitted in illustration) for closing the opening portion 25. At the assembly position of the cover 13, engagement portions (omitted in illustration) provided at the first housing 3 and the cover 13 are engaged with each other, the assembly state of the cover 13 with respect to the first housing 3 is maintained. When the cover 13 closes the opening portion 25, the bolt 11 is not exposed to the outside, and safety can be maintained. When fastening of the bolt 11 is incomplete, the cover 13 abuts against the bolt 11 while the cover 13 moves from the standby position to the assembly position, and the cover 13 cannot move. As a result, the cover 13 cannot be assembled to the first housing 3. Thus, the fastening state of the bolt 11 can be detected based on the assembly state of the cover 13 with respect to the first housing 3, and reliability of electric connection between the first conductive member 7 and the second conductive member 9 can be maintained.

Incidentally, when the bolt 11 is inserted into or drawn from the opening portion 25 every time fitting between the first housing 3 and the second housing 5 is achieved or cancelled, management such as storage of the bolt 11 in addition to that of the connector 1 is required. In view of this, when the fastening portion 55 of the bolt 11 is fastened and temporarily held to the nut 47 to a certain extent, management of the bolt 11 in addition to that of the connector 1 is not required. However, when the first through hole 45 and the second through hole 53 are annular, the bolt 11 cannot be inserted into or removed from the first through hole 45 and the second through hole 53. Thus, while the bolt 11 is temporarily held, fitting between the first housing 3 and the second housing 5 cannot be achieved or cancelled.

In view of this, as illustrated in FIG. 3, FIG. 5, and FIG. 6, the second through hole 53 is provided with an insertion opening 63 into which the bolt 11 can be inserted. The insertion opening 63 is opened to communicate with the second through hole 53 from the distal end of the second conductive member 9 along the fitting direction of the first housing 3 and the second housing 5. The width of the insertion opening 63 is set to be larger than the diameter of the fastening portion 55 so that the fastening portion 55 of the bolt 11 can be inserted thereinto, and is constant from the distal end of the second conductive member 9 to the second through hole 53. The second through hole 53 is provided with the insertion opening 63, and thus the fastening portion 55 of the bolt 11 can be inserted into or removed from the insertion opening 63 while the bolt 11 is temporarily held by the first through hole 45 of the first conductive member 7. Thus, with regard to fitting between the first housing 3 and the second housing 5, the fastening portion 55 of the bolt 11 can be inserted from the insertion opening 63 into the second through hole 53, and thus the first housing 3 and the second housing 5 can be fitted to each other. In contrast, with regard to cancelation of fitting between the first housing 3 and the second housing 5, the fastening portion 55 of the bolt 11 positioned in the second through hole 53 can be removed from the insertion opening 63, and thus fitting between the first housing 3 and the second housing 5 can be cancelled. Thus, management of the bolt 11 in addition to that of the connector 1 is not required, and assemblability can be improved. The outer edge of the second conductive member 9 provided with the insertion opening 63 is covered with an insulating member 65 formed of an insulating material such as a synthetic resin. When the outer edge of the second conductive member 9 is covered with the insulating member 65, contact with the outer edge of the second conductive member 9 can be prevented during insertion or removal of the bolt 11 with respect to the insertion opening 63, and safety can be maintained.

The connector 1 described above includes the first housing 3, the second housing 5 that can be fitted to the first housing 3, and the first conductive member 7 that is accommodated in the first housing 3 and includes the first through hole 45. The connector 1 further includes the second conductive member 9 that is accommodated in the second housing 5 and includes the second through hole 53 arranged at the position matching with the first through hole 45 while the first housing 3 and the second housing 5 are fitted to each other. The connector 1 further includes the bolt 11 that electrically connects the first conductive member 7 and the second conductive member 9 to each other by being inserted into the first through hole 45 and the second through hole 53 for fastening. Further, in one of the first through hole 45 and the second through hole 53 (specifically, the second through hole 53 in this case), the insertion opening 63 into which the bolt 11 can be inserted is provided, the insertion opening 63 being opened toward the fitting direction of the first housing 3 and the second housing 5.

The second through hole 53 is provided with the insertion opening 63, and thus the bolt 11 can be inserted into or removed from the insertion opening 63 while the bolt 11 is temporarily held by the first through hole 45 of the first conductive member 7. Thus, with regard to fitting between the first housing 3 and the second housing 5, the bolt 11 can be inserted from the insertion opening 63 into the second through hole 53, and thus the first housing 3 and the second housing 5 can be fitted to each other. In contrast, with regard to cancelation of fitting between the first housing 3 and the second housing 5, the bolt 11 positioned in the second through hole 53 can be removed from the insertion opening 63, and thus fitting between the first housing 3 and the second housing 5 can be cancelled.

Therefore, in the connector 1 described above, the bolt 11 can be held temporarily, and management of the bolt 11 in addition to that of the connector 1 is not required, which can improve assemblability.

Further, the outer edge of one of the first conductive member 7 and the second conductive member 9 (specifically, the second conductive member 9 in this case) in which the insertion opening 63 is provided is covered with the insulating member 65.

Thus, when insertion or removal of the bolt 11 with respect to the insertion opening 63 is performed, contact with the outer edge of the second conductive member 9 can be prevented, and safety can be maintained.

Further, the nut 47 to which the bolt 11 inserted into the first through hole 45 and the second through hole 53 is fastened is fixed to the other one of the first through hole 45 and the second through hole 53 (specifically, the first through hole 45 in this case).

Thus, it is not required to provide the first housing 3 or the second housing 5 with a fastening portion such as a terminal block to which the bolt 11 is fastened, and the structures of the first housing 3 and the second housing 5 can be simplified.

Further, the bolt 11 is fastened from the opening portion 25 provided in one of the first housing 3 and the second housing 5 (specifically, the first housing 3 in this case). Further, the opening portion 25 is closed by the cover 13 assembled to the one of the first housing 3 and the second housing 5 (specifically, the first housing 3 in this case). Further, the cover 13 can be assembled to the one of the first housing 3 and the second housing 5 (specifically, the first housing 3 in this case) while the bolt 11 is completely fastened.

Thus, the fastening state of the bolt 11 can be detected based on the assembly state of the cover 13 with respect to the first housing 3, and reliability of electric connection between the first conductive member 7 and the second conductive member 9 can be maintained.

While the present embodiment is described above, the present embodiment is not limited thereto, and various modification may be made within the scope of the gist of the present embodiment.

For example, the two first conductive members and the two second conductive members (forming two sets) are provided, but the numbers are not limited thereto. One first conductive member and one second conductive member (forming one set) or three or more first conductive members and three or more second conductive members (forming three sets or more) may be provided.

Further, the insertion opening is provided to the second through hole, but is not limited thereto. The insertion opening may be provided to the first through hole. In such a case, the nut may be fixed to the second through hole.

Further, in the first housing, the first accommodation portion and the fitting portion extend in the orthogonal directions, but are not limited thereto. The first accommodation portion and the fitting portion may extend in parallel directions. In such a case, similarly to the second conductive member, the first conductive member may be formed to have a linear plate-like shape.

Further, the opening portion is provided to the first housing, but is not limited thereto. When the first through hole and the second through hole are positioned on the inner side of the second housing, the opening portion may be provided to the second housing. In such a case, the cover may be assembled to the second housing. Note that the cover may be provided to any one of the first housing and the second housing as long as the opening portion can be closed.

Further, the cover is assembled integrally with the first housing via the engagement portions, but is not limited thereto. The cover may be prepared separately from the first housing without the engagement portions, and may be assembled to the first housing so as to close the opening portion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a first housing;
a second housing configured to be fitted to the first housing;
a first conductive member being accommodated in the first housing and including a first through hole;
a second conductive member being accommodated in the second housing and including a second through hole arranged at a position matching with the first through hole while the first housing and the second housing are fitted to each other; and
a bolt configured to electrically connect the first conductive member and the second conductive member to each other by being inserted into the first through hole and the second through hole for fastening, wherein
one of the first through hole and the second through hole is provided with an insertion opening into which the bolt is configured to be inserted, the insertion opening being opened toward a fitting direction of the first housing and the second housing.

2. The connector according to claim 1, wherein
an outer edge of one of the first conductive member and the second conductive member in which the insertion opening is provided is covered with an insulating member.

3. The connector according to claim 1, wherein
a nut is fixed to the other one of the first through hole and the second through hole, the nut being fastened by the bolt inserted into the first through hole and the second through hole.

4. The connector according to claim 1, wherein
the bolt is fastened from an opening portion provided in one of the first housing and the second housing,
the opening portion is closed by a cover assembled to the one of the first housing and the second housing, and
the cover is configured to be assembled to the one of the first housing and the second housing while the bolt is completely fastened.
